(19) United States
(12) Patent Application Publication
(10) Pub. No.: US 2023/0363873 A1
(43) Pub. Date: Nov. 16, 2023

(54) DENTAL HANDHELD DEVICE FOR CURING A POLYMER

(71) Applicant: Ivoclar Vivadent AG, Schaan (LI)

(72) Inventors: Bruno Senn, Gais (CH); Oliver Benz, Schaan (LI)

(21) Appl. No.: 18/314,036

(22) Filed: May 8, 2023

(30) Foreign Application Priority Data
May 10, 2022 (EP) 22172471.9

(51) Int. Cl. A61C 13/15; G02B 27/10

(52) U.S. Cl. CPC A61C 19/004; G02B 27/1006

(57) ABSTRACT

A dental handheld device (100) for curing a polymer using light, having a laser diode as a first light source (101-1) for outputting light in a first wavelength range; and a second light source (101-2) for outputting light in a second wavelength range.

### CROSS-REFERENCE TO RELATED APPLICATIONS

This application claims priority to European Patent Application No. 22172471.9 filed on May 10, 2022, the disclosure of which is incorporated herein by reference in its entirety.

### TECHNICAL FIELD

The present invention relates to a dental handheld device for curing a polymer using light and a dental method for curing a polymer using light.

It is the technical object of the present invention to make a dental handheld device more efficient and energy-saving.

US 20220273410, 20070031777, 20040076921 and 20020175628 are directed to light curing devices and are hereby incorporated by reference in their entirety.

### SUMMARY

This technical object is solved by objects according to the independent claims. Technically advantageous embodiments are the subject of the dependent claims, the description and the drawings.

According to a first aspect, the technical object is solved by a dental handheld device for curing a polymer by means of light, comprising a first light source comprising a laser diode for outputting light in a first wavelength range; and a second light source for outputting light in a second wavelength range. The light beam from the laser diode expands only slightly. By combining a laser diode and a light emitting diode, less heat is generated and the efficiency of the dental handheld device is increased. Both better curing directly on the surface and a higher surface quality are achieved. The dental handheld device can be produced with a smaller battery and with less material. The laser diode can also be used to effectively cure fillings at a greater distance, a divergence of the emitted light is small. By combining with another light source, the dental handheld device can produce a wide spectrum.

In an advantageous embodiment of the dental handheld device, the intensity maximum of the first wavelength range is between 440 and 460 nm. This provides the technical advantage, for example, that this wavelength range can be efficiently generated with a laser diode. There is less heat generation and lower energy consumption. In addition, a straighter radiation and advantageous penetration depth are achieved.

In a further advantageous embodiment of the dental handheld device, the intensity maximum of the second wavelength range is between 400 and 420 nm. This provides, for example, the technical advantage of achieving better curing directly at the surface and a higher surface quality.

In a further advantageous embodiment of the dental handheld device, the first light source has a higher radiation power than the second light source. This achieves, for example, the technical advantage that the dental handheld device can be used for as many materials as possible independently of an initiator system.

In a further advantageous embodiment of the dental handheld device, the second light source comprises a laser diode or a light-emitting diode. This achieves, for example, the technical advantage that particularly suitable light sources are used.

In a further advantageous embodiment of the dental handheld device, the dental handheld device is designed to operate the first and second light sources simultaneously. This achieves the technical advantage, for example, that the curing of the polymer is accelerated and/or an improvement in the physical properties is achieved.

In a further advantageous embodiment of the dental handheld device, the dental handheld device comprises a bundle of light-conducting fibers. This provides, for example, the technical advantage that the light from the two light sources can reach the polymer to be cured efficiently.

In a further advantageous embodiment of the dental handheld device, the laser diode is arranged in such a way that the light from the laser diode impinges on the light-conducting fibers of the bundle. This achieves, for example, the technical advantage that the homogeneity of the outgoing light is improved.

In a further advantageous embodiment of the dental handheld device, the beam directions of the first and second light sources are perpendicular to each other. This achieves, for example, the technical advantage that the light beams of the two light sources can be superimposed in a simple manner.

In a further advantageous embodiment of the dental handheld device, the dental handheld device comprises a beam coupler for superimposing the light beams of the two light sources. This achieves, for example, the technical advantage that the light sources can be arranged at different locations and do not interfere with each other.

In a further advantageous embodiment of the dental handheld device, the beam coupler comprises an edge filter. This provides the technical advantage, for example, that certain wavelength ranges of the light beam can be absorbed.

In a further advantageous embodiment of the dental handheld device, the dental handheld device comprises a collimating lens for parallelizing the light from the first and/or second light source. This achieves, for example, the technical advantage that parallel light beams can be generated which can be superimposed in a simple manner.

In a further advantageous embodiment of the dental handheld device, the dental handheld device comprises a reflector for reflecting the light and/or a lens for collimating the light. This achieves, for example, the technical advantage that an exit pupil is homogeneously illuminated and/or good collimation of the exiting light is achieved.

In a further advantageous embodiment of the dental handheld device, the reflector and the lens are formed by a one-piece optical element. This has the technical advantage, for example, of simplifying the construction of the dental handheld device.

According to a second aspect, the technical object is solved by a dental method for curing a polymer by means of light, comprising the steps of outputting light in a first wavelength range by a first light source comprising a laser diode; and outputting light in a second wavelength range by a second light source. Thereby, the same technical advantages are achieved as by the dental handheld device according to the first aspect.

### BRIEF DESCRIPTION OF THE DRAWINGS

Examples of embodiments of the invention are shown in the drawings and are described in more detail below.

The figures show:

FIG. 1 a representation of a dental handheld device;

FIG. 2 a spectrum of a generated light;

FIG. 3 a block diagram of a process;

FIG. 4 a schematic representation of an embodiment of a dental handheld device; and

FIG. 5 a further schematic representation of an embodiment of a dental handheld device.

### DETAILED DESCRIPTION

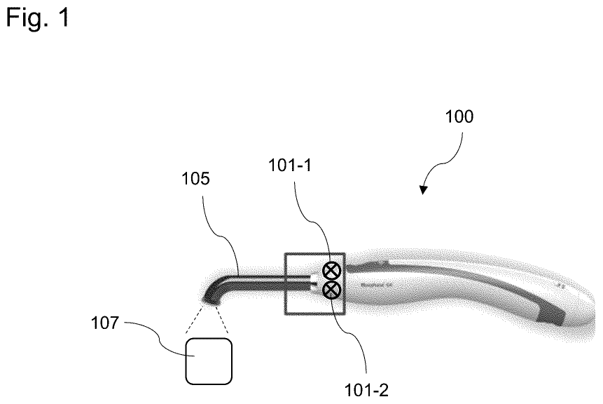

FIG. 1 shows an illustration of a dental handheld device 100 for curing a polymer using light. The dental handheld device 100 comprises a first light source 101-1 comprising a laser diode for outputting light in a first wavelength range 103-1. In addition, the dental handheld device 100 comprises a second light source 101-2 for outputting light in a second wavelength range 103-2. The first and second light sources 101-1 and 101-2 are disposed inside the dental handheld device 100. The wavelength ranges 103-1 and 103-2 are different from each other, but may partially overlap.

Light from the two light sources 101-1 and 101-2 is directed through a light guide 105 to a polymer 107 to be photoinduced cured, such as a dental filling. To power the two light sources 101-1 and 101-2, the dental handheld device 100 comprises, for example, an accumulator. The two light sources 101-1 and 101-2 may be independently controlled by appropriate control electronics.

The second light source 101-2 may comprise a laser diode or a light emitting diode. The dental handheld device is configured to operate the first and second light sources 101-1 and 101-2 simultaneously. In this manner, the spectra of the respective light sources 101-1 and 101-2 may be superimposed and output together by the dental handheld device 100.

A light emitting diode is a semiconductor device that emits light by spontaneous emission when electric current flows in the forward direction. In the opposite direction, the light-emitting diode blocks. The wavelength of the emitted light depends on the semiconductor material and the doping of the diode. For example, an indium gallium nitride (InGaN) light-emitting diode can be used to emit light with a wavelength of 460 nm or 410 nm.

A laser diode is a semiconductor device that generates coherent laser radiation by means of stimulated emission. In laser diodes, a p-n junction with heavy doping is operated at high current densities. The end faces of the device are partially reflective and thus form an optical resonator in which a standing wave of light can be formed. The choice of semiconductor material determines the emitted wavelength. For example, a blue laser diode based on gallium nitride can be used as the laser diode. The light from the laser diode has an aperture angle of 0 to 5°, for example. Due to the directional radiation of the laser diode, the intensity can be maintained over a greater distance. In addition, a greater penetration depth into the polymer is achieved.

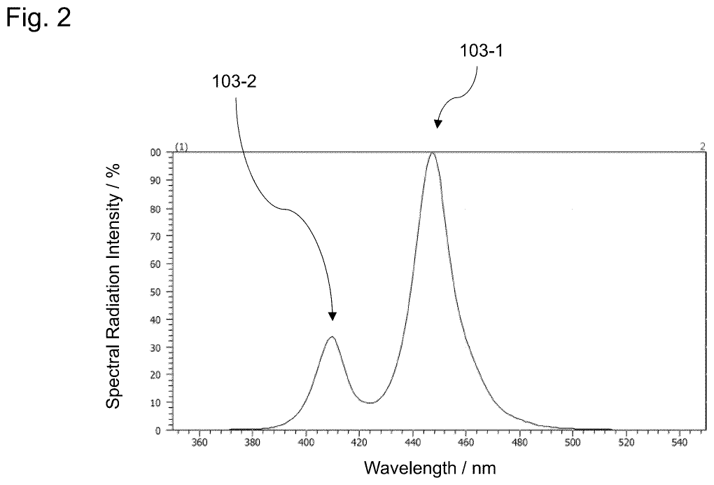

FIG. 2 shows a spectral radiant power of the dental handheld device 100 as a function of the respective wavelength. The spectral radiant power has two peaks. The first peak is located at a wavelength of 450 nm and is generated by the first light source 101-1. The second peak is at a wavelength of 410 nm and is generated by the second light source 101-2. The peak of the wavelength range 103-1 has a higher power than the peak of the second wavelength range 103-2. The first light source 101-1 is configured to generate light with a higher power than the second light source 101-2.

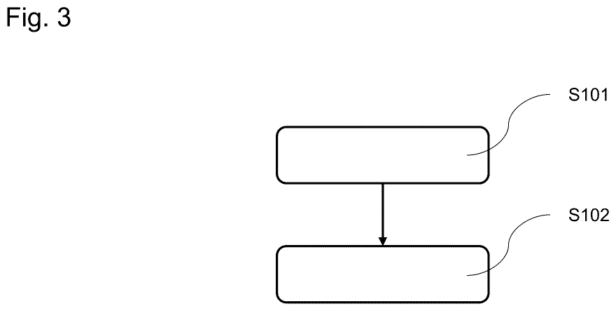

FIG. 3 shows a block diagram of a dental method for curing a polymer using light. The dental method comprises the step S101 of outputting light in the first wavelength region 103-1 by the first light source 101-1 comprising a laser diode. Further, the dental method comprises the step S102 of outputting light in a second wavelength range by a second light source 101-2.

Using a laser diode as the light source 101-1, the main light for through-curing is generated in a wavelength range around 450 nm. Using another light source 101-2 comprising a light emitting diode or laser diode, light is generated in a second wavelength range around 410 nm. The light from both light sources 101-1 and 101-2 is directed to the light-curable dental material using optics.

The laser diode has a higher efficiency so that a battery of the dental device 100 lasts longer. In addition, the light output of the laser diode 101-2 is directional. Since the divergence of the emitted light is small, fillings at a greater distance can be effectively cured.

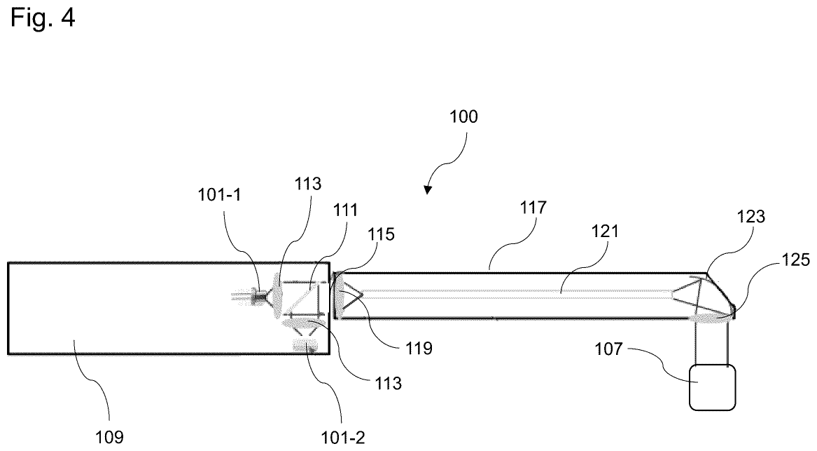

FIG. 4 shows a schematic representation of an embodiment of a dental handheld device 100. The dental handheld device 100 comprises a hand part 109. In the hand part 109, there is the first light source 101-1 with a laser diode that emits light with a wavelength of 450 nm. In addition, the handheld device includes the second light source 101-2 comprising a light emitting diode that emits light having a wavelength of 405 nm.

The light with the wavelength of 450 nm and the light with the wavelength of 405 nm are each passed through collimating lenses 113. The collimating lenses 113 are used to generate light with an approximately parallel beam path from the light sources 101-1 and 101-2. This collimation serves to give the light a specific direction.

Then, the parallel light from the two light sources 101-1 and 101-2 is passed through an edge filter 111 as a beam coupler for wavelength coupling. Through the edge filter 111, the light beams of the two light sources 101-1 and 101-2 are superimposed and guided in the same direction. The edge filter 111 has two more or less sharply separated spectral ranges in which the edge filter transmits (is transmissive) and absorbs (is opaque), respectively. The beam coupler is formed, for example, by a disk arranged at an angle of 45° in the beam path of the two light sources 101-1 and 101-2. The light beam from the laser diode passes through the disk in a straight line, while the light beam from the light emitting diode is reflected from the surface of the beam coupler. In this way, the light beams from the laser diode and the light emitting diode can be efficiently superimposed. For example, the edge filter 111 blocks in a wavelength range starting at a wavelength greater than the wavelength emitted by the light source 101-1.

A collimated (parallel) light beam 115 emerges from the handheld device 109. This light beam 115 is directed into an illumination head 117. The illumination head includes a focusing lens 119 with which the light beam 115 is focused.

A bundle of light-conducting fibers 121 is arranged inside the illumination head 117. The focused light beam enters the bundle of light-conducting fibers 121. The bundle of light conducting fibers 121 serves to guide the light from the handheld device 109 to the location where the polymer 107 is located.

In this regard, the laser diode of the dental handheld device 100 illuminates only the inner fibers of the bundle 121, causing the light from the laser diode to enter only the inner fibers of the bundle 121. To this end, the dental handheld device 100 may include, for example, a pinhole aperture that causes the light from the laser diode to strike only an inner portion of the light-conducting fibers 121, while leaving an outer portion of the light-conducting fibers 121 unilluminated. The outer fibers 121 of the bundle 121 remain unilluminated by the laser diode. In contrast, the light from the light-emitting diode enters not only the inner portion of the light-conducting fibers 121, but also the outer portion of the light-conducting fibers 121. As a result, greater homogeneity at the exit and better radiation characteristics can be achieved.

The light from the bundle 121 then exits the bundle and strikes a reflector 123, such as in a parabolic shape. An exit pupil can be homogeneously illuminated by the reflector 123. After reflection, the light beam exits the illumination head 117 through a lens 125. Renewed collimation is achieved through the lens 125. The reflector 123 and the lens 125 may be made of a single transparent part, such as by a one-piece optical element.

This design achieves high homogeneity in the exit pupil, a small field angle and good collimation. A collimated light beam is created at the interface between the handheld device 109 and the illumination head 117. Polychromatic light with a high power can be output from the dental device 100.

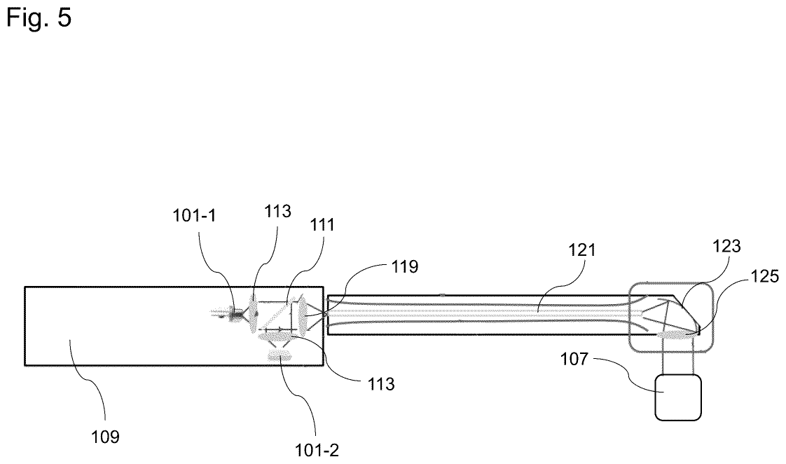

FIG. 5 shows another schematic representation of an embodiment of a dental handheld device. In this embodiment, the focusing lens 119 is arranged inside the handheld device 109. As a result, a focused beam of light is emitted from the handheld device 109 at the interface between the handheld device 109 and the illumination head 117.

A bundle of light-conducting fibers 121 is also arranged in the illumination head 117. The laser diode illuminates the fibers of the bundle 121. The illumination head 117 can be of elastic design and have different diameters. This allows illumination of the polymer 107 to be performed in inaccessible locations. The illumination head 117 may be formed by an injection molded part.

Also, in this embodiment of the dental device 100, a high homogeneity in the exit pupil, a small field angle and a good collimation are achieved. A focused light beam is formed at the interface between the handheld device 109 and the illumination head 117, which can be easily coupled into the light conducting fibers 121. In addition, polychromatic light with a high power can be output from the dental device 100.

All features explained and shown in connection with individual embodiments of the invention may be provided in different combinations in the subject-matter of the invention to simultaneously realize their beneficial effects.

All method steps can be implemented by means which are adapted for executing the respective method step. All functions that are executed by objective features can be a method step of a method.

The scope of protection of the present invention is given by the claims and is not limited by the features explained in the description or shown in the figures.

### REFERENCE LIST

100 Dental handheld device
101 Light source
103 Wavelength range
105 Light guide
107 Polymer
109 Handheld device
111 Edge filter
113 Collimation lenses
115 Light beam
117 Lighting head
119 Focusing lens
121 Bundle of light conducting fibers
123 Reflector
125 Lens

1. A dental handheld device (100) for curing a polymer (107) by light, comprising
a first light source (101-1) comprising a laser diode for outputting light in a first wavelength range (103-1); and
a second light source (101-2) for outputting light in a second wavelength range (103-2).

2. The dental handheld device (100) according to claim 1,
wherein an intensity maximum of the first wavelength range (103-1) is between 440 and 460 nm.

3. The dental handheld device (100) according to claim 1,
wherein an intensity maximum of the second wavelength range (103-2) is between 400 and 420 nm.

4. The dental handheld device (100) according to claim 1,
wherein the first light source (101-1) has a higher radiation power than the second light source (101-2).

5. The dental handheld device (100) according to claim 1,
wherein the second light source (101-2) comprises a laser diode or a light emitting diode.

6. The dental handheld device (100) according to claim 1,
wherein the dental handheld device (100) is adapted to operate the first and second light sources (101-1, 101-2) simultaneously.

7. The dental handheld device (100) according to claim 1,
wherein the dental handheld device (100) comprises a bundle of light conducting fibers (121).

8. The dental handheld device (100) according to claim 7,
wherein the laser diode is arranged such that light from the laser diode is incident on the light conducting fibers (121) of the bundle.

9. The dental handheld device (100) according to claim 1,
wherein the beam directions of the first and second light sources (101-1; and 101-2) are perpendicular to each other.

10. The dental handheld device (100) according to claim 1,
wherein the dental handheld device (100) comprises a beam coupler (111) for superimposing light beams of the two light sources (101-1) and (101-2).

11. The dental handheld device (100) according to claim 10,
wherein the beam coupler (111) comprises an edge filter.

12. The dental handheld device (100) according to claim 1, comprising
a collimating lens (113) for collimating light from the first and/or second light source (101-1, 101-2).

13. The dental handheld device (100) according to claim 1, comprising
a reflector (123) for reflecting the light and/or a lens (125) for collimating the light.

14. The dental handheld device (100) according to claim 13,
wherein the reflector (123) and the lens (125) are formed by a one-piece optical element.

15. A dental curing method for curing a polymer (107) by light, comprising
outputting (S101) light in a first wavelength range (103-1) by a first light source (101-1) comprising a laser diode; and
outputting (S102) light in a second wavelength range (103-2) by a second light source (101-2).
